(19) United States
(12) Patent Application Publication
(10) Pub. No.: US 2008/0022327 A1
(43) Pub. Date: Jan. 24, 2008

(54) SYSTEM, METHOD, AND COMPUTER PROGRAM PRODUCT FOR REMOTE PRINTING

(75) Inventors: William R. Murray, Livermore, CA (US); Philip G. Wessells, Mill Valley, CA (US); Ken Madellin, Bethlehem, PA (US)

Correspondence Address: PATENT LAW OFFICES OF MICHAEL E. WOODS, 3433 WHEELING DRIVE, SANTA CLARA, CA, 95051, US

(73) Assignee: QOOP, INC., Mill Valley, CA (US)

(21) Appl. No.: 11/309,187

(22) Filed: Jul. 7, 2006

(51) Int. Cl. H04N 7/173; H04N 7/18; H04N 7/16

(52) U.S. Cl. 725/82; 725/133; 725/141; 725/74; 725/78

(57) ABSTRACT

A method used in an information processing apparatus for transferring a set of images from a server unit over a network and controlling a printing process of the transferred set of images, the method comprising: a) forming an image selection method at a local network device for identifying the set of images; b) communicating the image selection method to the server unit over the network; c) receiving, at a network device other than the local network device, the set of images from the server unit over the network responsive to the image selection method; d) arranging the set of images into a layout on the network device other than the local network device; e) converting the layout into a page description language (PDL) format file; and f) communicating the PDL format file to a printer over the network.

### CROSS REFERENCE TO RELATED APPLICATIONS

The present invention is related to U.S. application Ser. No. 10/691,128 filed 22 Oct. 2003 and entitled “SYSTEM, METHOD, AND COMPUTER PROGRAM PRODUCT FOR NETWORK RESOURCE PROCESSING” and related to U.S. application Ser. No. 10/719,685 filed 21 Nov. 2003 and entitled “SYSTEM, METHOD, AND COMPUTER PROGRAM PRODUCT FOR NETWORK RESOURCE PROCESSING,” both hereby expressly incorporated in their entireties by reference herein.

### BACKGROUND OF THE INVENTION

The present invention relates generally to remote printing of network resources, and more specifically to remote printing of image sets derived from a network-accessible image database and bound into a physical/tangible output.

The Internet includes a great number of network resources accessible by users of local network devices. These resources include web pages, documents, spreadsheets, presentations, sound files, image files, and the like. A user of a local network device is able to obtain a local copy of a particular one of these network resources from the Internet using an identifier. Providing a Uniform Resource Locator (URL) as the identifier is common since the URL is a standard used by many Internet applications including web browsers for locating and accessing a copy of a desired network resource. The prior art also uses the Universal Naming Convention (UNC) or the directory/file structure (DFS) as resource identifiers. These and other systems for specifying a particular resource available over private and public networks are included in the term “resource identifier.”

In well-known fashion, a process on a network device directly operated by a user (e.g., a web browser executing on a personal computer coupled to the Internet) locates a copy of a network resource and downloads a copy to a local memory of the local network device. Many processes include built-in (or add-in) viewers to format and present the network resource using the local network device. For example, the network resource may describe a web page in hypertext markup language (HTML) and the process receives the HTML and presents it on a display of the local network device. Other resources include documents in a particular word processing format (e.g., Corel® WordPerfect® or Microsoft® Word®), audio format (e.g., MP3), video (e.g., QuickTime, real audio, or AVI), still images (e.g., GIF, TIFF, or JPEG), or other resource type.

As discussed above, there are many different format types for different resources with some resource types having developed special viewer requirements. Some formats are so popular that they are a viewed as a “standard.” Viewers for such resources are easily obtained when appropriate viewers are not already incorporated into various processes of the local network device.

One such particularly useful format is a Portable Document Format (PDF) developed by Adobe Systems Incorporated, 345 Park Avenue, San Jose, Calif. 95110-2704. PDF permits a PDF-viewer (e.g., Adobe Acrobat) to present document content on a display associated with the local network device in virtually the same way as it would be presented if the content were printed. The pagination and content formatting of each page is preserved in the PDF without regard to the type of local printer or local display used in the viewing or printing of a document in PDF.

It is common for users of local network devices to operate the local network device and “surf” the Internet to locate one or more desirable network resources for local ‘consumption.’ These resources range widely and may be a document, a song, or a video clip, or any of the resources identified above. Once located, it is not uncommon for the user to desire to have a tangible version of the network resource such as a printed document or a compact disk (CD) having the song or video clip.

For many network resources, processing resources available to the local network device may be insufficient to efficiently produce the tangible version of the network resource. Some documents are very long, often using multiple colors, and may be formatted for a different medium-size than conventionally possessed by the local user. The more complicated the network resource is, the wider the disparity may be between the display characteristics of the resource and the ability of the user to produce a satisfactory tangible copy using the local resources. In some cases, the local resources may technically be capable of producing the tangible copy, but the production is inefficient or unsatisfactory for a variety of reasons. For example, for a document several hundreds of pages in length, consumer grade printers are typically too slow and unreliable to replicate each of the pages in sufficient quality. Also, many simple print finishing options like binding and glossy cover pages, much less more complicated finishing options such as book preparation or generation of tens to hundreds or more of copies of the content, are not practicable if available.

It is a further disadvantage when a web site provides resources to a user for review, printing, or access. The limited resources (local computer resources, printing/finishing and bandwidth) available to the users of the web site make it virtually impossible for the user to produce a desired exemplar of the web site document. First, the limited bandwidth may interfere with the user efficiently identifying the appropriate content because each sample may need to be downloaded to the user's local computer for review (provided that the user has enough free memory available to store a local copy). Second, the user then has a local copy of this document that is unlikely to be able to be used locally for the reasons set forth above. Third, many resources accessed from web sites have cryptic names that can be virtually impossible to remember, and since resources are downloaded to many different locations, and some of these locations are in multi-level subdirectories also having cryptic folder names, locating a particular local file accessed from the Internet can be extremely tedious if not nearly impossible.

This difficulty exists for others besides web site operators. Authors, publishers, distributors, and other owners/licensees of content have similar difficulties in making their content available in an appropriate electronic format, the concerns of digital rights management aside. It is a serious impediment to distribution when the user is unable to review and control production of a satisfactory copy of content, particularly for content that is likely to have been paid for. The user does not want poor quality paper, uneven images, blank or missing pages, or smudged toner marks on the pages, particularly when there may be nothing more than a rubber band to hold the stack of pages together, with a flat-tone black and white printed page as the cover.

The prior art has known the use of proprietary print drivers available to processes on a local network device. These drivers enable a user to operate on local content on the local network device and transmit the content in a special proprietary format to a remote device for further processing. This has been done with image and document resources created on the local network device. These solutions are disadvantageous for several reasons. The driver operates on the file using the local computer and uploads the reprocessed file to a production facility.

The proprietary driver is typically not incorporated into a commonly used resource production or editing process. A user is required to produce the resource (e.g., a document or image) using one process and use the proprietary driver to send the content with special formatting to a remote network device for further processing. The remote network device has a corresponding or compatible driver that attempts to accurately reproduce the formatting of the process on the local network device. It is often the case that there is not one hundred percent fidelity in reproducing the content formatting from the process using the proprietary drivers, and in certain cases the fidelity is much less than one hundred percent. An inability to guarantee fidelity has been a weakness in these solutions, and the chances of inaccuracy increases as new versions of resource producing processes are released having new features, and in some cases new resource formats. The proprietary driver typically is not available upon release of the new version, and the driver often still fails to produce a truly accurate reproduction after it becomes available. Users are then required to ensure that they have the right version of the proprietary driver installed to match their process, and they have to properly install the proprietary driver which is often a difficult task.

Another disadvantage of these types of prior art systems is that the content is moved from a local network device to a remote network device. While the use of broadband connectivity is not uncommon among users, connectivity speeds are based upon analog modem speeds for the larger share of users. Transmitting large files representing long or complex documents from a local network device to a remote network device will deter many users of these types of systems. Even for those users having a broadband connection, accessing and retrieving a very large file can be problematic. The term “broadband” has many different meanings to a wide range of people, but in its most general it refers to connections having a communication speed faster than a single modem. Such a definition is not useful as many different connection types and speeds are included. It is the case that most broadband connection speeds are asynchronous having a significant difference between a speed into a local network device from a remote network as compared to a speed into the same remote network device from the same local network device. For many uses, this speed difference is acceptable and does not adversely affect the tasks desired on the local network device. For example, streaming video or audio files, or receiving large document or image files from the remote network device are facilitated by the relatively large bandwidth speed into the local network device. Since few users desire to stream or upload large files from the local network device to the remote network device, the asynchronous connection does not interfere with many current tasks. The disparity between a download speed and an upload speed can be significant, sometimes one or more orders of magnitude different.

However, in the context of manipulating and transmitting large image files to the remote network device, the relatively slow upload speed is a drawback to the use and implementation of certain services and features. For example, FedEx Kinko's Online and Print Services enables a user to print a document at a remote Kinko's facility, and then retrieve the printed document from the facility. An advantage of this system is that the user may make use of professional printing, binding, and other finishing options. A disadvantage is that many of the files, if not most of the files, that a user desires to print using such a service, are much larger than an average file size. The unusually large size and the relatively slow upload speeds creates a real and perceived significant drawback to solutions such as the FedEx Kinko's online printing system. Often with systems like this, the designers impose a maximum physical size limit that constrains use artificially.

In the more narrow context of digital photography, another format that can create digital files of relatively large size, additional problems arise. The proliferation of digital cameras and digital video recorders has created a need for increased storage capacity, image editing, and image management. Over the years, a certain model has developed in which users are provided online tools to receive, store, and manage their digital images. One reason that such online models have developed is that they often provide a mechanism by which selected digital images may be shared selectively among various select groups of people. There are many such online services, two relatively new services include flickr (http://www.flickr.com) and Buzznet (http://www.buzznet.com) that promote and enhance development and sharing of extensive online image databases.

Most of the tools developed and implemented for services such as these deal with the online aspects of the model; improving uploading, organization, and sharing are predominate themes. One drawback to the digital photography model, as well as the attendant online models related thereto, is that the users are increasingly separated from an ability to generate hardcopies of various individual photos, or sets of photos. Early solutions provided for a user to purchase a photographic printing system and connect it to their local network device and print one-off photographs. A group of users with sufficient motivation, training, and resources (including money and time) are able to invest in local layout tools and create photo books. However, most local printing systems are insufficient to do justice to these productions, decreasing a desire to invest in development of these local systems. And many binding and finishing options are just unavailable to local printing systems. Thus, solutions such as the FedEx Kinko's Online Printing solution developed. Over time, improvements have been made and enhanced tools have been provided. For example, Apple Computer (http://www.apple.com) provides an option for photo book production from its iPhoto application. Similarly, My Publisher (http://www.mypublisher.com) provides for tools for the development of books (including photo books). These tools include local layout and editing utilities to select, arrange, and process local images on the local network device to create a file in an acceptable format. In these solutions, the user must then upload the formatted file to the publishing service from the local network device, thereby encountering the bandwidth disparity problems, among other issues associated with uploading large files. The expertise required in use of these tools, the drawback of having each user upgrade their local tools with improved versions, and the bandwidth problem create significant impediments to implementation of these solutions for developing simple and efficient solutions for printing a photo book of a group of images available to a user. These problems are compounded for a user of an online photograph management and sharing service as the user must download copies of the selected images (or maintain two possibly non-synchronized duplicate libraries (remote and local)) before using many of these printbook systems. This further decreases the chances that these solutions will be adopted.

Other drawbacks of generating automatically a hardcopy of a set of digital images include: a) is too common that some incompatibilities exist between a digital version of a photograph or image viewed through an image viewer and a rendering of the image onto a print medium, and b) these incompatibilities are not always consistently the same across the image set. For example, an image may appear to problem-free but printing it may produce undesirable features or artifacts—these can result from attributes of the image capture process, the image conversion process, and/or the image storage process. One such parameter may be dots per inch (DPI). One factor that influences a DPI is the number of pixels in the image capture device. Some image processing software permits a user to alter the resolution of an image. A DPI setting may affect how big a final image is when printed, as a function of the resolution (DPI) of the printing system. The resolution of the image and the resolution of the printing system are not required to match.

Another potential incompatibility is that print media typically conforms to one of a set of standard sizes—especially for printing a “book” of photographs. There is no such requirement for digital images—each image of a set may have a different physical size and this may be affected by the DPI issue discussed above.

What is needed is a simple and efficient solution for selecting, organizing, processing, and printing photo books from online image databases to provide improved quality physical photo books that may implement custom covers, custom content, and desired finishing/binding options.

### BRIEF SUMMARY OF THE INVENTION

Disclosed is a method used in an information processing apparatus for transferring a set of images from a server unit over a network and controlling a printing process of the transferred set of images, the method comprising: a) forming an image selection method at a local network device for identifying the set of images; b) communicating the image selection method to the server unit over the network; c) receiving, at a network device other than the local network device, the set of images from the server unit over the network responsive to the image selection method; d) arranging the set of images into a layout on the network device other than the local network device; e) converting the layout into a page description language (PDL) format file; and f) communicating the PDL format file to a printer over the network.

Preferred embodiments of the present invention include apparatus, computer program product, and propagated signals implementing and/or using this method. The preferred embodiments provide for a simple and efficient mechanism for a user, having used an online webservice for managing their digital photographs, to obtain photo books of their photographic assets without requiring that the online webservice develop an expertise in printing in addition to online digital management. The solution offers users that do not have sufficient local resources for producing quality digital images and resources for binding pages of a book and/or those having processing bandwidth limitations (e.g., download/upload speeds, computer processing power, memory, digital photo editing tools, and the like) an ability to simply select a set of photographs and subsequently generate an attractive, cost-effective photo book that, in some implementations, includes a custom cover derived from the set of photographs. As noted above, it is too common that some incompatibilities exist between a digital version of a photograph or image viewed through an image viewer and a rendering of the image onto a print medium. An image may appear to problem-free but printing it may produce undesirable features, particularly across a set of previously unrelated images. The preferred embodiment detects and adapts for many of the most-common causes of incompatibilities to improve the automatic generation of a photo book of selected digital images.

The novel features which are characteristic of the invention, as to organization and method of operation, together with further objects and advantages thereof, will be better understood from the following description considered in connection with the accompanying drawings in which one or more preferred embodiments of the invention are illustrated by way of example. It is to be expressly understood, however, that the drawings are for the purpose of illustration and description only and are not intended as a definition of the limits of the invention. These drawings include the following figures, with like numerals indicating like parts.

### BRIEF DESCRIPTION OF THE DRAWINGS

FIG. 1 is a computer system that may function as a basic computer in implementing the present invention;

FIG. 2 is a generalized block diagram of a preferred embodiment for a system of the present invention;

FIG. 3 is a flow diagram for a preferred embodiment of the present invention of a photo book generation process;

FIG. 4 through FIG. 7 are representative screenshots of a user interface of the preferred embodiment illustrating a user experience in generating a photo book;

FIG. 4 is a screenshot of the user interface for selecting an output selection type;

FIG. 5 is a screenshot of the user interface for selecting a desired set of images for the photo book;

FIG. 6 is a screenshot of the user interface for selecting various additional options for the photo book to be generated; and

FIG. 7 is a screenshot of the user interface for presenting a preview of the photo book and other photo book generation details.

### DETAILED DESCRIPTION OF THE INVENTION

The preferred embodiments of the present invention relate to an efficient photo book generation system, method, computer program product, and propagated signal solution that provides a user with simple and quick identification, selection, and/or retrieval of a set of images for production of a custom photo book, including in some embodiments provision of a photo book cover having a subset of the set of images. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

The preferred embodiments of the present invention are implemented between a user local network device, a network server device controlling access to an image pool, a remote network device (other than the local network device and network server device), and one or more network printers all communicated to each other using communication protocols. An operator of the user local network device identifies a set of images from the image pool, the images are retrieved and processed remote from the local network device to produce a digital representation of a photo book (e.g., generation of the contents and in some cases a cover for the contents) in a page description language format (e.g., Adobe's Acrobat portable document format (PDF)) compatible with the printer to generate a plurality of pages collectively defining the pages or pages and cover for the photo book. The pages are then finished (e.g., bound) to produce a hardcopy photo book and then made available (e.g., shipped) as specified by the operator.

The operator communicates with the remote network device to initiate the remote network device to interactively or automatically identify, select, and/or retrieve the set of images from the server and locate them on a network device other than the server or the user local network device, which in some cases may include the remote network device. The remote network device, responsive to the operator in the preferred embodiment, defines and generates the digital representation of the photo book and initiates the production of the physical photo book using at least the printer and may include other finishing components part of the printer or cooperative with the printer.

It is part of the preferred embodiment that the user local network device, the server, and the remote network device are all independent systems. For example, the user local network device is a conventional home computer system, the server is a system of computing systems operated by an image service such as flickr or Buzznet, and the remote network device is a computing system operated by a third-party, e.g., QOOP, Inc., of Mill Valley, Calif. (www.qoop.com).

The server operator permits the operator to upload images and to perform various tasks with the uploaded images by using a web browser to “log” into the server using the user credentials and to perform the various tasks typically using the web browser. Server operators like Flickr and Buzznet have also provided an external API (application programming interface) by which operators of remote network devices (like Qoop) may directly access images from the server without using the web browser interactive interface. Images on the server may be available either to the general public or they may be “private” and require the operator credentials to access/process. The API provides an ability for the remote network operator to access public and private images using operator credentials when necessary.

In other embodiments, the operator uses services of the server to identify and select an image set and then directs the server to use the API to directly communicate with the remote network device.

An API for purposes of the preferred embodiments includes a set of definitions of the ways one piece of computer software communicates with another. The API is a mechanism for achieving abstraction, usually (but not necessarily) between lower-level and higher-level software, but also between two independent pieces of software (such as those owned and operated by two or more independent entities).

One of the primary purposes of an API is to provide a set of commonly-used functions—for example, to draw windows or icons on a screen or display. Programmers may then take advantage of the API by making use of its functionality, saving them the task of programming everything from scratch. APIs are abstract: software that provides a certain API is often called the implementation of that API. For purposes of the preferred embodiment, these functions are referred to as callable methods and API endpoints. The methods and endpoints are often made available to developers as part of API documentation or in a Software Development Kit (SDK) and typically vary from provider to provider. For example, Flickr makes its API documentation available, for example on its website at www.flickr.com/services/api. This API documentation is hereby expressly incorporated by reference in its entirety for all purposes. Other providers have different APIs and it is well-known that some adaptation and configuration is required for implementation of any particular API.

By the nature of general purpose computing systems used for these tasks, including special programmed personal computers, workstations, servers, personal digital assistants (PDAs), cellular telephones, and other electronic devices and the like used in accessing resources via resource identifiers, have great versatility. This versatility contributes to the challenge in accessing specific, relevant resources amongst the multitudes of candidate resources and potential resources (some resources are dynamically generated so the different lists that may be generated are virtually limitless).

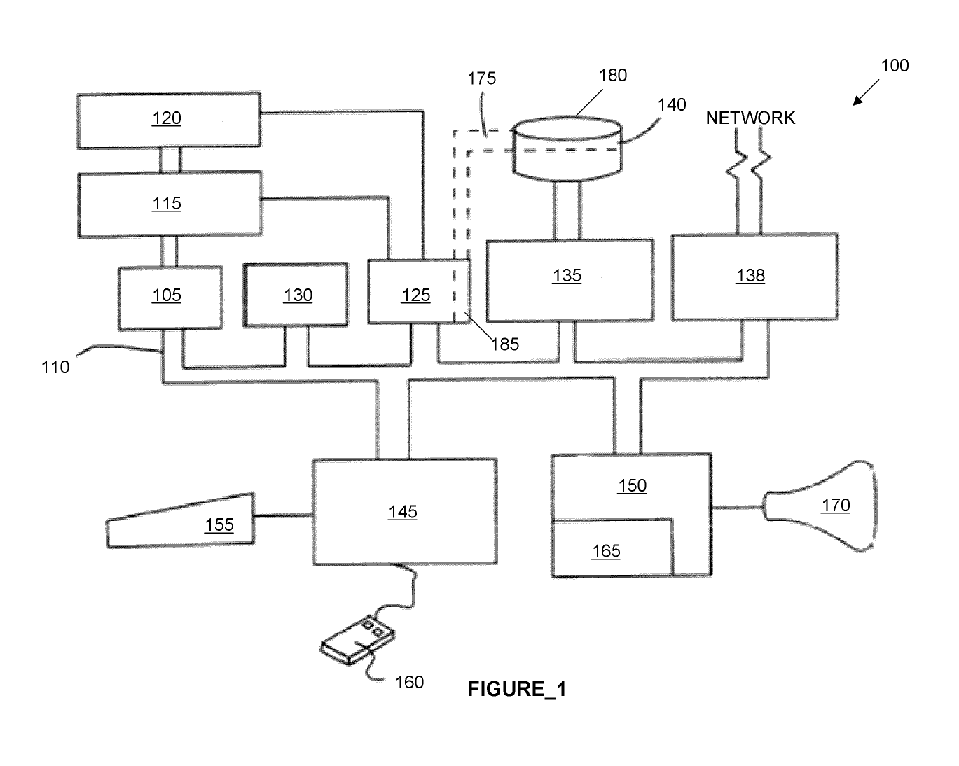

FIG. 1 is a computer system 1 00 that may function as a basic computer in implementing a preferred embodiment of the present invention for an efficient interface solution that provides a user with simple and quick searches across a plurality of locations, and one that may be expanded without complicated or time-consuming configuration options. Computer system 100 includes a central processing unit (CPU) 105, such as one of the PC microprocessors or workstations, e.g. RISC System/6000 (RS/6000) (RISC System/6000 is a trademark of International Business Machines Corporation) series available from International Business Machines Corporation (IBM) or other processors from Advanced Micro Devices, Intel, Motorola, MIPS Technologies, Inc., and the like, is provided and interconnected to various other components by a system bus 110. An operating system 115 runs on CPU 105, provides control and is used to coordinate the function of the various components of FIG. 1. Operating system 115 may be one of the commercially available operating systems such as the AIX 6000 operating system or OS/2 operating system available from IBM (AIX 6000 and OS/2 are trademarks of IBM); Microsoft's Windows (95, 98, ME, NT, 2000, and XP), as well as UNIX and AIX or Apple Computer operating systems. One or more application programs 120, controlled by the system, are moved into and out of a main memory RAM 125. These programs include the program of the present invention to be subsequently described in combination with local or wide-area network systems, such as for example, the Internet. A read only memory (ROM) 130 is connected to CPU 105 via bus 110 and includes the Basic Input/Output System (BIOS) that controls the basic computer functions. RAM 125, an I/O adapter 135 and a communications adapter 138 are also interconnected to system bus 110. I/O adapter 135 may be a Small Computer System Interface (SCSI) adapter that communicates with a disk storage device 140, though other well-known interfaces may be used. Communications adapter 135 interconnects bus 110 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160) are all interconnected to bus 110 through user interface adapter 145. It is through such input devices that the user may interactively relate to the programs for an efficient interface solution that provides a user with simple and quick searches\retrievals\accesses across a plurality of locations, and one that may be expanded without complicated or time-consuming configuration options according to the preferred embodiments. Display adapter 150 includes a frame buffer 165, which is a storage device that holds a representation of each pixel on a monitor or display screen 170. Images may be stored in frame buffer 165 for display on monitor 170 through various components, such as a digital to analog converter (not shown) and the like. By using the aforementioned I/O devices, a user is capable of inputting information to the system through the keyboard 155 or mouse 160 and receiving output information from the system via display 170. The system also contains a memory cache 175 which is illustrated as a dashed line outline and includes a portion 180 of a disk storage drive 140 and a portion 185 of RAM 125.

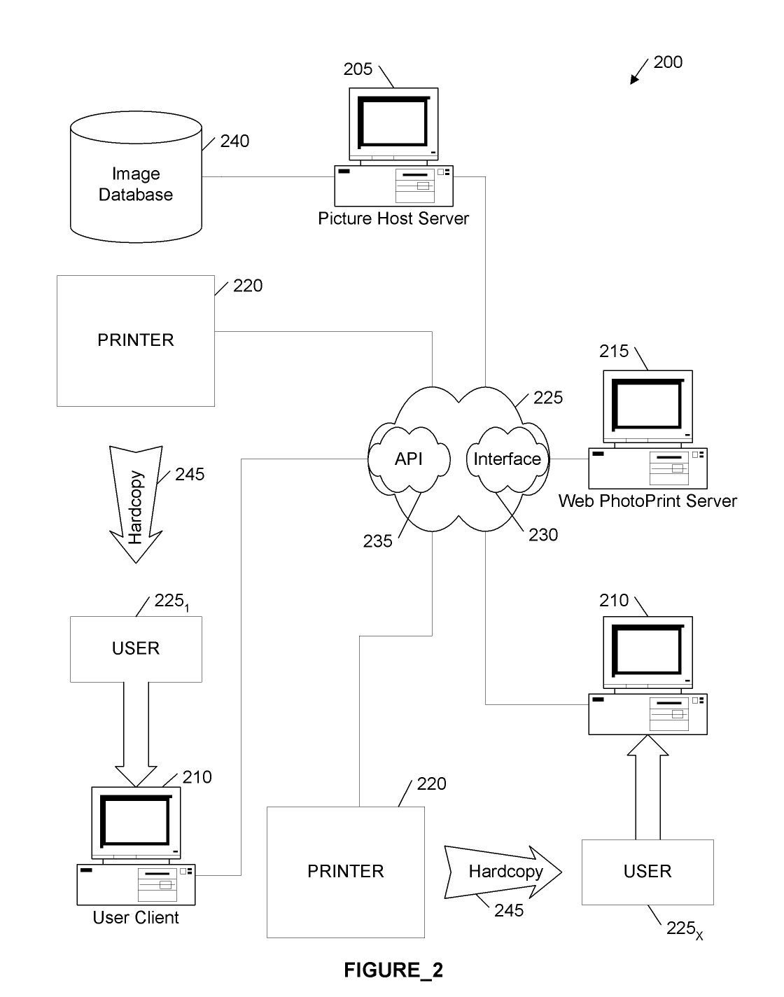

FIG. 2 is a generalized block diagram of a preferred embodiment for a system 200 of the present invention. System 200 includes a picture host server 205, a plurality of user clients 210, a photoprint server 215 and one or more book printing services 220, all communicated together over a network 225. A user 225ₓ operates one of user client 210 to communicate with photoprint server 215 via an interface 230 and an application programming interface (API) 235 to select images from a database 240 operable with host server 240 and specific printing options to produce a hardcopy 245 from one or more of printing services 220. In the preferred embodiment, hardcopy 245 is produced remote from the specific user 225ₓ making the request, and made available such as through delivery or pickup, In some cases, a user generates a local copy from their client 210 using a downloaded resource.

Host server 205 represents any of the online digital image management services, such as flickr or Buzznet or the like, or other similar arrangements that use a network-accessible server, typically employing a world-wide web (WWW) Internet browser, to select, view, manage, share, and otherwise process digital image files (or other digital file) from database 240. User 225ₓ is able to access images from database 240, either public images or their own private images using an account and password, by operating a browser operable on their user client 210.

User client 210 is preferably a specially programmed computing system of the type shown in FIG. 1 that includes resources as described to support a user interface function to access and display a set of images from database 240. In the preferred embodiment, this user interface function is a portion of interface 230 that is accessible and operable by user 225. Interface 230 is shown as part of network 225 since it is accessible through the interface. In actuality it may be resident on or distributed across one or more of host server 205, user client 210, and/or photoprint server 215. Similarly, API 235 is shown as part of network 225 to represent a distributed aspect—API 235 is in this view a protocol existing between host server 205 and/or user client 210 and/or photoprint server 215.

The user interface function of user client 210 uses interface 230 to interact with photoprint server 215 to cause photoprint server 215 to form an image selection method using API 235 to identify a set of images from database 240. Photoprint server 215 communicates the image selection method to server 205 and causes it to access database 240. The selection method may require authentication or account access credentials in the case of non-public images. It is also possible that the user interface function may access photoprint server indirectly through accessing host server 205.

Photoprint server 215 receives the set of images from server 205 over the network responsive to the image selection method, with photoprint server 215 arranging the set of images into a layout and converting the layout into a page description language (PDL) format file according to user options and settings, and communicates the PDL format file to one or more appropriate printing services 220 over network 225.

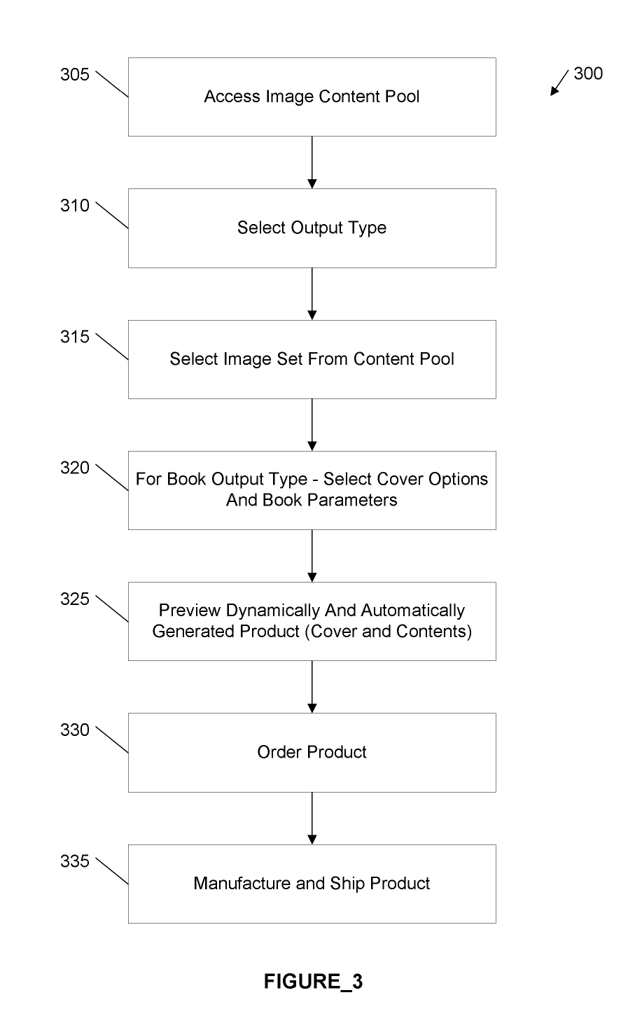

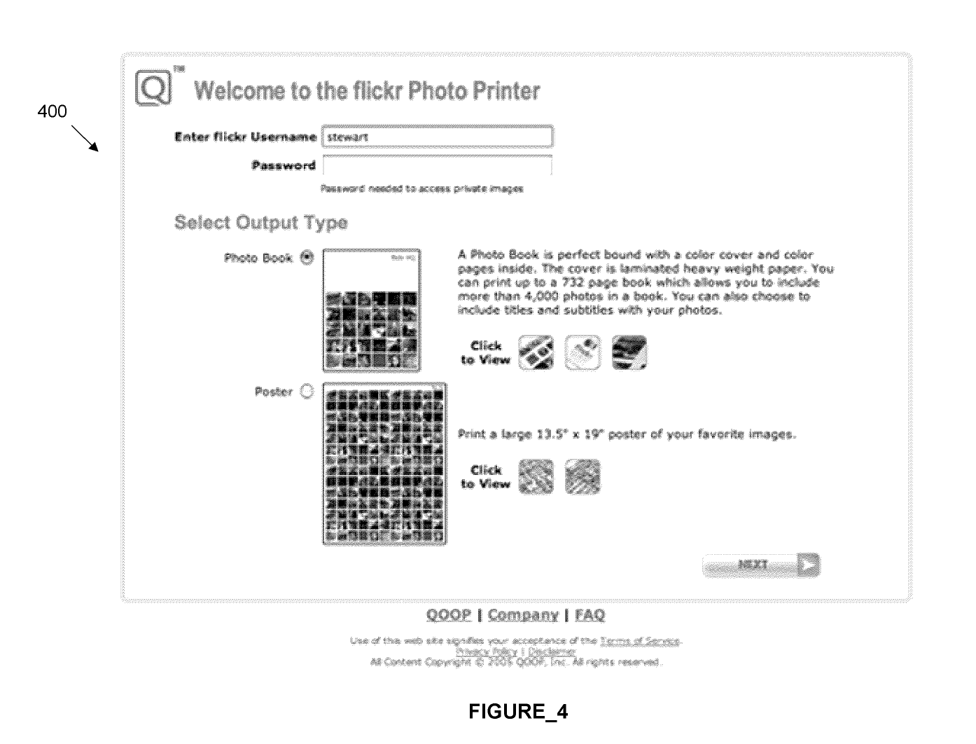

FIG. 3 is a flow diagram for a preferred embodiment of the present invention of a photo book generation process 300. The discussion of process 300 will refer to representative screenshots of the user interface function. FIG. 4 through FIG. 7 are representative screenshots of a user interface of the preferred embodiment illustrating a user experience in generating a photo book.

Process 300 begins with step 305 to access an image content pool to select a candidate set of images. Process 300 next uses the user interface function to select an output type at step 310. FIG. 4 is a screenshot 400 of the user interface for selecting the candidate set and an output selection type. In the preferred embodiment implemented for Flickr, the candidate image set is determined by a flickr username (passwords are used for non-public images) with the username identifying images for the user account. In some implementations, the candidate image set is not limited to images from a single user, nor does it always include all images available to a user. The username is one way for server 205 to define which set of images are the baseline image set for further processing.

In the preferred embodiment, photoprint server 215 provides user 225ₓ with one of two output types: a photo book or a poster. There are some refinements to subsequent operation of process 300 based upon the output type but for simplicity the photo book output type will be described below. Modification of the process for the poster output type is considered within the scope of the person of ordinary skill, just as adaptation of process 300 for other output types. For example, it is also possible to output templates for hardcopy 245 and to then apply these templates to other objects, such as coffee cups, t-shirts and other objects. In these variations, process 300 for identification and selection and use of a specific group of the candidate image set may be readily modified as necessary or desirable for the particular implementation or embodiment.

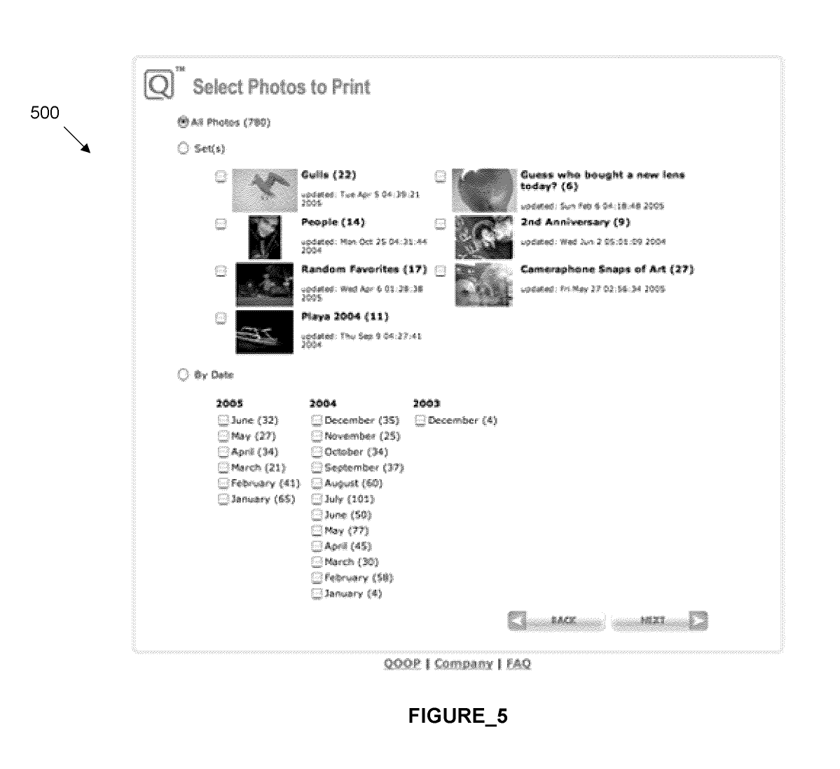

After step 310, process 315 presents an interface element to permit user 225 to select an image set from the content pool. FIG. 5 is a screenshot 500 of the user interface function for selecting a desired set of images for the photo book. As shown in FIG. 5, the flickr service, through configuration of host server 205 and its associated database 240, provides a user with a mechanism of organizing, arranging, and identifying images in various content pools. Some of these ways include photo sets where the user creates named groupings of sets of its images. Additionally, the flickr service provides a user with an ability to associate date information with its images. Photoprint server 215 provides user with an ability to select the image set as ALL photos, one or more of the user-predefined sets, or other specific selection criteria such as date(s) or date ranges. As shown in FIG. 5, the user interface function provides the user with an image count for each possible selection (shown in parentheses for each selection) to provide user 225 with a sense of the potential size of the generated photo book. This information is obtained from host server 205 using API 235 as appropriate.

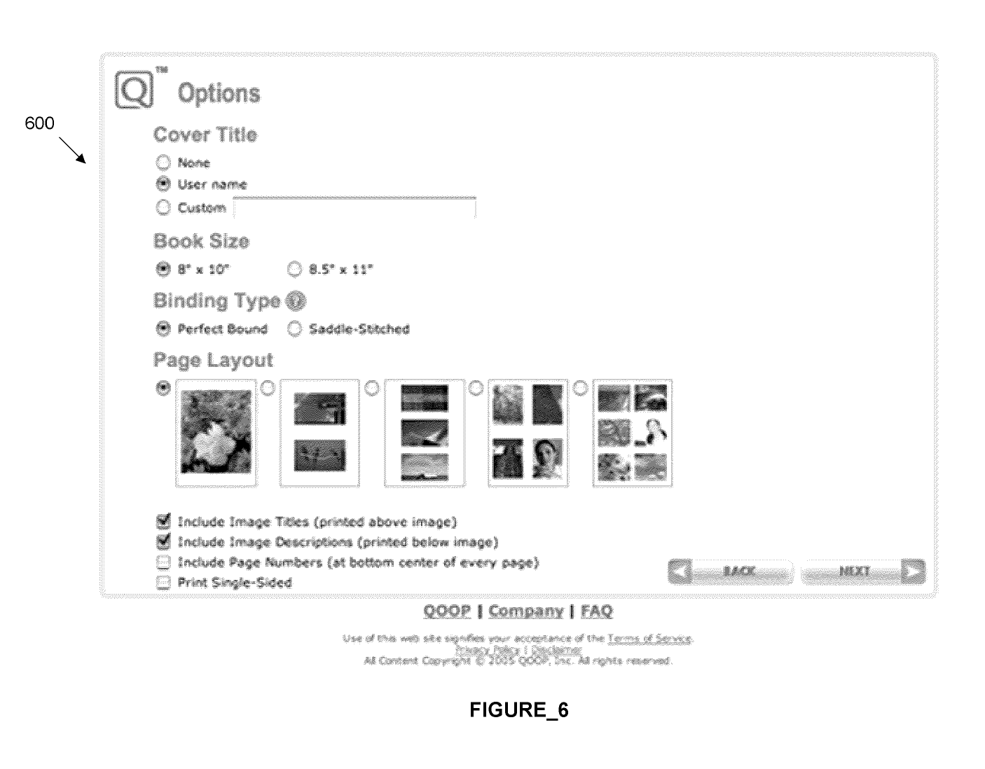

After step 315, process 300 presents user 225 with the user interface function configured to select cover option and other photo book parameters. FIG. 6 is a screenshot 600 of the user interface for selecting various additional options for the photo book to be generated. These options include cover options (e.g., title information—no title, the username, or a custom value), book size (e.g., 8″×10″ or 8.5″×11″), binding type (e.g., perfect bound or saddle-stitched), and page layout options (e.g., number/arrangement of images per page, as well as options to include image titles and descriptions, page numbers and single-sided/double-sided printing. Some of this information is provided by the user and some is automatically extracted from database 240 when desired by user 225.

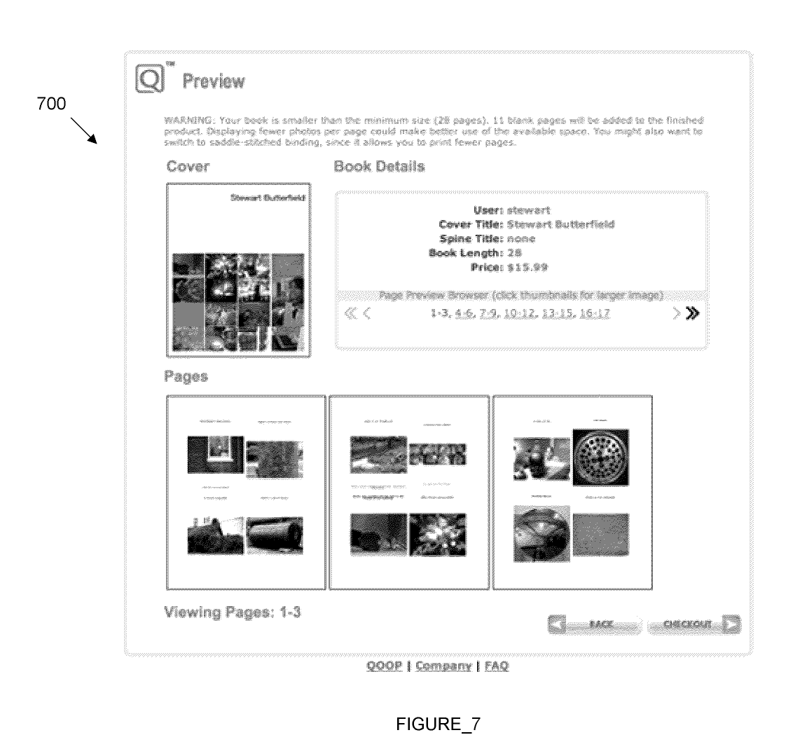

Next at step 425 process 300 provides a preview of the dynamically and automatically generated photo book—including the cover and contents. FIG. 7 is a screenshot 700 of the user interface function for presenting a preview of the photo book and other photo book generation details. The preview includes thumbnails of the cover as well as a subset of the pages (for example three pages at a time). User 225 may select a thumbnail to enlarge it for detailed inspection as well as selecting other subsets of thumbnails for review. In addition, other parameters of the photo book are included—such as the username, the cover title, the spine title (if any), a total length and the single unit price for hardcopy 245 of the photo book being displayed. Each user interface function shown in FIG. 4 through FIG. 7 includes a “back” and “next” function to back up and select different options or advance process 300 using the current selected options.

After the preview step 325, process 300 advances to step 330 for user 225 to “Checkout” for completing the payment/shipping options as appropriate. Process 300 may provide for payment options for individual orders, it may permit access to preestablished accounts, or it may permit third-party payment or sponsorship of the photo book generation. User delivery/pickup information is also provided in the checkout step and may include multiple copies of hardcopy 245 to multiple recipients.

Process 300 concludes with step 335 by manufacturing hardcopy 245 and shipping it as specified in the checkout phase. System 200 is shown as optionally including multiple printing services 220. In some cases printing services are arranged geographically and/or by type of hardcopy 245 manufactured.

In process 300, photoprint server 215 produces the layout in a page description language (PDL), such as for example PDF. In some cases, the description of the image selection and information gathering, and image access is simplified by reference to the use of the API. In some cases, the computing systems of system 200 communicate with each other using many different methods and data exchanges in order to access and acquire images and metadata associated with individual images, collections of images, and information about the content pool and user account.

As discussed above, process 300 includes various tests and routines for automatically testing, validating, and correcting/adjusting certain image abnormalities to permit dynamic and automatic implementation of process 300. In the preferred embodiment, process 300 is performed without manufacturer intervention and is controlled by operation of the user interface function interactions with interface 230 and API 235 in cooperation with host server 205 and photoprint server 215 as well as printing services function 220.

In addition to these tests, validations, and corrections/adjustments, the preferred embodiment of process 300 may include one or more different algorithmic functions for generation of the cover. In the preferred embodiment, process 300 generates a cover image file that is combined with the contents file to produce hardcopy 245. However, in other implementations, process 300 may provide for defining hardcopy of a single digital image in PDL having both the cover and the contents.

In the preferred embodiment, process 300 generates the cover having a regular ordered matrix of image thumbnails uniformly sized (e.g., an N×M matrix of same-sized images). In some implementations, the user may manually select the images for the cover and provide specific placement in the matrix. In other cases, process 300 automatically determines cover thumbnail images to use on the cover, the cover thumbnail images selected from specific ones of the images used in the contents of the photo book. In some cases, a hardcover book may be generated by production of a hardcover (e.g., a stamped leather book).

Process 300 in the preferred embodiment is able to automatically create the regular ordered matrix even when all the images of the image set are not all uniformly sized. Process 300 does this by first creating a candidate cover image set. This candidate cover image set is populated with a subset of the images of the image set that are all uniformly sized. Second, the values for N and M are selected in the preferred embodiment to produce a sufficiently sized regular ordered matrix with unique thumbnail images. That is, when the candidate cover image set includes sixteen images that may used in the regular ordered matrix, N and M may be 4×4, 2×8, 3×4, 4×3, 2×2 and other permutations. When the candidate cover image set includes fifteen images, the 4×4 option is not available. In some degenerate cases where every image is different, it may be that M and N are both equal to one. In some implementations, a user may select some specific values for M and N that are valid based upon this test, while in the preferred embodiment, process 300 automatically selects values from M and N. Actual implementations may vary from this in that there may be some minor variations in the actual images selected for inclusion in the matrix, such as for those instances when images vary by a few pixels or less. The system selects a threshold for “matching” image sizes and those matching, within tolerances, may be selected for the set.

As should be clear, the present invention is not limited to any particular operating system, CPU-type, resource access application (e.g., a specific browser-type) or type or types of resources accessed or retrieved. The preferred embodiments of the present invention may be implemented/adapted for many different platforms, operating systems, computing systems, interfaces, resource access applications and the like without departing from the spirit and teachings of the present invention.

In some of these implementations, interface 905 may be integrated into an application, process, operating system and transparent to the user as it is available indirectly by the type of resource and elements in the resource. In other implementations, interface 905 may be transitioned between transparent and explicit operation, or selected features may be exposed or concealed from a user or operator. The physical embodiments of the system may vary as well—such as personal computer/browser solutions, or stand-alone kiosk solutions, such as for example public use. In other implementations, some or all of the user-functions may be combined/automated such that, given any required access information (e.g., a username/password) various defaults and automatic options may be used to completely automate the identification, extraction, layout, and production of a hardcopy representation of a set of data files.

In some instances, a preferred implementation of the present invention includes a simple “middleware” solution that is communicated to a third-party database (e.g., a storehouse of image data) via a standardized interface (e.g., an API) and communicated to a hardcopy output system (e.g., a printer). Many conventional solutions require that all processing be done on a local machine—including selection and layout—and then uploaded to an output solution. In some cases as discussed above, the user may have additional input in specifics of layout and cover production. For example, a web browser may be configured using coding language (e.g., Java or the like) to receive representations of the images/contents (e.g., thumbnails or down-sampled images or in some cases full image data) and permit a real-time arrangement that is communicated to the layout system used to generate the output.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 1, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, and the like as described above. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A method used in an information processing apparatus for transferring a set of images from a server unit over a network and controlling a printing process of the transferred set of images, the method comprising:
a) forming an image selection method at a local network device for identifying the set of images;
b) communicating said image selection method to the server unit over the network;
c) receiving, at a remote network device, the set of images from the server unit over the network responsive to said image selection method, said remote network device a network device other than said local network device;
d) arranging the set of images into a layout on said remote network device;
e) converting said layout into a page description language (PDL) format file; and
f) communicating said PDL format file to a printer over the network.

2. The method of claim 1 wherein said PDL format file includes a portable document format (PDF) compatible format.

3. The method of claim 1 wherein said image selection method is constructed using methods provided as part of an Application Programming Interface (API) of the server unit for a processing of one or more images managed by the server unit.

4. The method of claim 3 wherein said processing is selected from the group consisting of one or more of identifying, selecting, or retrieving, or combinations thereof.

5. The method of claim 1 wherein said PDL format file is a first PDL format file and wherein the method further comprises:
g) forming algorithmically a cover layout specification;
h) converting said cover layout specification into a second PDL format file; and
i) communicating said second PDL format file to said printer over the network for use as a cover for a hardcopy of said first PDL format file.

6. The method of claim 1 wherein said layout is a content, the method further comprising:
g) forming algorithmically a cover layout specification using said PDL format;
h) merging said cover layout specification into said PDL format file; and
i) communicating said PDL format file to said printer over the network to provide a hardcopy of said cover layout specification as a cover for a hardcopy of said content of said PDL format file.

7. The method of claim 5 wherein said cover layout specification includes an arrangement of selected images that are derived from one or more of the set of images.

8. The method of claim 7 wherein said arrangement of selected images include at least one algorithmically selected image representation not expressly selected and arranged by an operator of said local network device.

9. The method of claim 7 wherein said arrangement of selected images includes at least one image representation expressly selected and arranged by an operator of said local network device.

10. The method of claim 1 further comprising:
g) generating a hardcopy of said PDL format file from said printer, said hardcopy including a plurality of pages including said set of images.

11. The method of claim 10 further comprising:
h) finishing said hardcopy by binding said plurality of pages into a photo book including said set of images.

12. The method of claim 11 further comprising:
i) initiating shipment of said photo book to a delivery address specified by an operator of said local network device.

13. The method of claim 6 further comprising:
j) generating said hardcopy of said first PDL format file including a plurality of pages having said set of images and a hardcopy of said second PDL format file from said printer.

14. The method of claim 13 further comprising:
k) finishing a photo book by binding said plurality of pages having said set of images with said cover.

15. The method of claim 14 further comprising:
l) initiating shipment of said photo book to a delivery address specified by an operator of said local network device.

16. The method of claim 1 wherein the set of images define at least a portion of a contents of a photo book, said method further comprising:
g) defining programmatically a subset of the set of images for an arrangement for a cover for said contents.

17. The method of claim 16 wherein said arrangement is a regular matrix.

18. The method of claim 17 wherein said subset defining step includes analyzing the set of images for an arrangement influencing property wherein said subset of images share a compatible characteristic for said arrangement influencing property.

19. The method of claim 17 wherein said subset defining step includes analyzing the set of images for an arrangement influencing property wherein said subset of images share a compatible characteristic for said arrangement influencing property, said arrangement influencing property including an aspect ratio of each image of the set of images and wherein said compatible characteristic includes substantial matching of said aspect ratio for said subset of images.

20. The method of claim 1 9 wherein said regular matrix includes a number of image locations responsive to a number of images in said subset of images.

21. The method of claim 1 further comprising:
g) generating, using said printer, an image transfer structure including said set of images;
h) applying said image transfer structure to an object to transfer said set of images to said object.

22. A computer program product comprising a computer readable medium carrying program instructions for transferring a set of print target images from a server unit over a network and controlling a printing process of the transferred set of print target images when executed using a computing system, the executed program instructions executing a method, the method comprising:
a) forming an image selection method at a local network device for identifying the set of images;
b) communicating said image selection method to the server unit over the network;
c) receiving, at a remote network device, the set of images from the server unit over the network responsive to said image selection method, said remote network device a network device other than said local network device;
d) arranging the set of images into a layout on said remote network device;
e) converting said layout into a page description language (PDL) format file; and
f) communicating said PDL format file to a printer over the network.

23. The product of claim 22 wherein said image selection method is constructed using methods provided as part of an Application Programming Interface (API) of the server unit for identifying, selecting, and transferring one or more images managed by the server unit.

24. The product of claim 22 further comprising:
g) forming algorithmically a cover layout specification;
h) converting said cover layout specification into a second PDF file; and
i) communicating said second PDF file to said first printer over the network for use as a cover for a hardcopy of said first PDF file.

25. The product of claim 24 wherein said cover layout specification includes an arrangement of selected images that are derived from one or more of the set of print target images.

26. The product of claim 25 wherein said arrangement of selected images include at least one algorithmically selected image representation not expressly selected and arranged by an operator of said local network device.

27. The product of claim 25 wherein said arrangement of selected images include at least one image representation expressly selected and arranged by an operator of said local network device.

28. The product of claim 22 further comprising:
g) generating a hardcopy of said first PDF file from said printer.

29. The product of claim 28 further comprising:
h) finishing said hardcopy by binding said multipages into a photo book including said set of print target images.

30. The product of claim 29 further comprising:
i) initiating shipment of said photo book to a delivery address specified by an operator of said local network device.

31. The product of claim 24 further comprising:
g) generating said hardcopy of said first PDF file and a hardcopy of said second PDF file from said printer.

32. The product of claim 31 further comprising:
h) finishing a photo book by binding said multipages having said set of print target images with said cover.

33. The product of claim 32 further comprising:
i) initiating shipment of said photo book to a delivery address specified by an operator of said local network device.

34. A propagated signal on which is carried computer-executable instructions which when executed by a computing system performs a method, the method comprising:
a) forming an image selection method at a local network device for identifying the set of images;
b) communicating said image selection method to the server unit over the network;
c) receiving, at a remote network device, the set of images from the server unit over the network responsive to said image selection method, said remote network device a network device other than said local network device;
d) arranging the set of images into a layout on said remote network device;
e) converting said layout into a page description language (PDL) format file; and
f) communicating said PDL format file to a printer over the network.

35. An apparatus, comprising:
means for forming an image selection method at a local network device for identifying the set of images;
means for communicating said image selection method to the server unit over the network;
means for receiving, at a remote network device, the set of images from the server unit over the network responsive to said image selection method, said remote network device a network device other than said local network device;
means for arranging the set of images into a layout on said remote network device;
means for converting said layout into a page description language (PDL) format file; and
means for communicating said PDL format file to a printer over the network.

36. An apparatus, comprising:
a local network device for forming an image selection method that identifies a set of print target images from a server unit, the local network device including a communicator for communicating said image selection method to said server unit over a network; and
a remote network device that receives, responsive to said image selection method, said set of print target images from said server unit over the network;
wherein said remote network device arranges said set of print target images into a layout on said network device other than said local network device and converts said layout into a first portable document format (PDF) file, and communicates said first PDF file to a first printer over said network.

37. A method used in an information processing apparatus for transferring a set of images from a server unit over a network, the method comprising:
a) forming an image selection method at a local network device for identifying the set of images;
b) communicating said image selection method to the server unit over the network; and
c) receiving, at a remote network device, the set of images from the server unit over the network responsive to said image selection method, said remote network device a network device other than said local network device.
